(19) United States
(12) Patent Application Publication
(10) Pub. No.: US 2004/0042043 A1
(43) Pub. Date: Mar. 4, 2004

(54) Data transmission apparatus

(75) Inventor: Kazuhiro Itagaki, Osaka (JP)

Correspondence Address: BURNS DOANE SWECKER & MATHIS L L P, POST OFFICE BOX 1404, ALEXANDRIA, VA, 22313-1404, US

(73) Assignee: MINOLTA CO., LTD.

(21) Appl. No.: 10/653,247

(22) Filed: Sep. 3, 2003

(30) Foreign Application Priority Data
Sep. 4, 2002 (JP) 2002-258910
Aug. 1, 2003 (JP) 2003-284953

(51) Int. Cl. G06F 15/00; G06F 13/00; G06F 3/12; G06F 3/00; G06F 11/30

(52) U.S. Cl. 358/1.15; 710/18; 358/1.16

(57) ABSTRACT

In a data transmission apparatus, a sender sends an e-mail and a request of returning confirmation of receipt of the e-mail to a destination, and a receiver receives the confirmation of receipt from the destination. A controller issues a transmission management report at predetermined timings, describing result of transmission for a plurality of transmissions in the transmission management report. The controller describes in the transmission management report a transmission or transmissions on which the result of transmission is uncertain when the transmission management report is issued.

This application is based on applications Nos. 2002-258910 and 2003-284953 filed in Japan, the contents of which are hereby incorporated by reference.

### BACKGROUND OF THE INVENTION

1. Field of the Invention

The present invention relates to a data transmission apparatus which transmits data through a network and issues a transmission management report on data transmission.

2. Description of Prior Art

An Internet facsimile, which can transmit image data attached to an e-mail though a network such as the Internet, becomes popular recently. Simple mode of transmission management for the Internet facsimile does not include confirmation of receipt of data. In this mode, the sending facsimile apparatus cannot receive confirmation of receipt of data from the receiving end, and a transmission management report states records on the transmission of image data (or e-mail) by the sending facsimile apparatus to the mail server. The transmission management report is usually issued when the number of transmissions reaches a predetermined number or when a predetermined time elapses.

On the other hand, in full mode of transmission management for the Internet facsimile, the sending facsimile apparatus can request to return confirmation of receipt of data. The request can be realized for example with the message distribution notification (hereinafter referred to as MDN) function used in e-mail system. The sending end of image data issues a transmission management report according to the response of MDN (that is, confirmation of receipt of data). For example, in a facsimile apparatus disclosed in Japanese Patent laid open Publication 2001-309109, a transmission management report is issued when a predetermined time elapses and the number of transmissions exceeds a predetermined number after sending the MDN request. If the predetermined time elapsed without receiving an MDN response to the MDN request, it is described for the transmission in the transmission management report.

However, in the Internet facsimile, the MDN response to the MDN request may not be received or it may take a long time until the MDN response is received, according to the environment at the receiving end. If an MDN response on the e-mail is not received until a predetermined time elapses, it is decided that the e-mail transmission is not yet delivered. The predetermined time is called wait time. When a transmission management report is issued, the result of transmission may not be confirmed if the wait time for MDN response has not elapsed. In such a case, the transmission management report is issued before final results of the transmissions are received, but such transmission management is not adequate.

### SUMMARY OF THE INVENTION

An object of the invention is to manage transmissions more easily for a data transmission apparatus which transmits data through a network.

In one aspect of the invention, a data transmission apparatus comprises a sender which sends an e-mail and a request of returning confirmation of receipt of the e-mail to a destination, a receiver which receives the confirmation of receipt from the destination, and a controller which issues a transmission management report at predetermined timings, describing result of transmission for a plurality of transmissions in the transmission management report. The controller describes in the transmission management report a transmission or transmissions on which the result of transmission is uncertain when the report is issued.

An advantage of the present invention is that transmission management becomes easier.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is a block diagram of a facsimile apparatus;

FIG. 2 is a block diagram of a control system of the facsimile apparatus;

FIG. 3 is a diagram of an example of transmission management report;

FIG. 4 is a diagram of another example of transmission management report;

FIG. 5 is a flowchart for controlling facsimile transmission; and

FIG. 6 is a flowchart of a subroutine of MDN receiving.

### DETAILED DESCRIPTION OF THE PREFERRED EMBODIMENTS

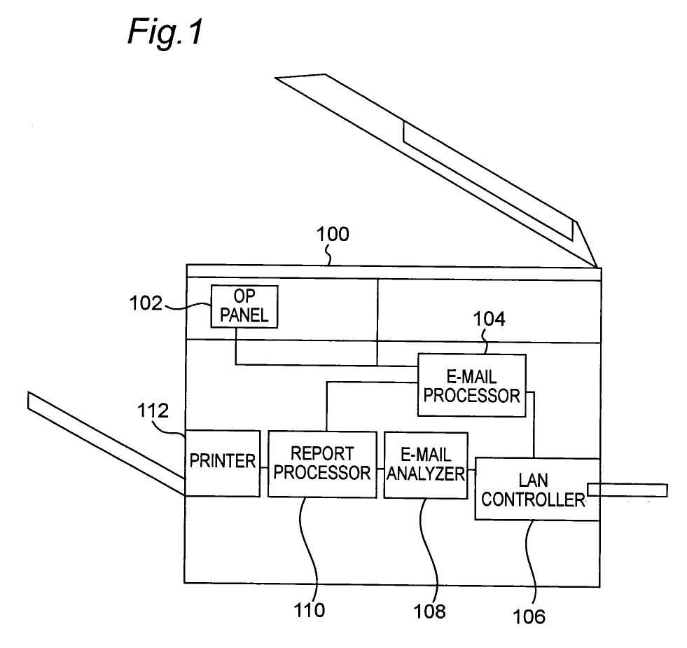

Referring now to the drawings, wherein like reference characters designate like or corresponding parts throughout the several views, FIG. 1 shows an entire facsimile apparatus of an embodiment according to the invention. The apparatus is for example a multi-functional peripheral equipped with facsimile function, and it can send or receive data by using the Internet facsimile function. (The data sending/receiving mentioned above are hereinafter referred to as facsimile sending/receiving.) A scanner 100 acquires image data by scanning a document put at a predetermined position on a platen thereof. An operational panel 102 is used to set a destination of facsimile transmission or the like. An e-mail processor 104 makes and sends an e-mail with attached image data of the document read by the scanner. The e-mail is sent to a receiving end connected to a network such as a local area network (LAN) or the Internet via a LAN controller 106. Further, data on the facsimile sending is sent to a report processor 110. In a case of facsimile receiving from the external, an e-mail received through the LAN controller 106 is analyzed by an e-mail analyzer 108, and the attached image data is printed by a printer 112. The LAN controller 106 consists of a sender which sends data to the external and a receiver which receives data from the external.

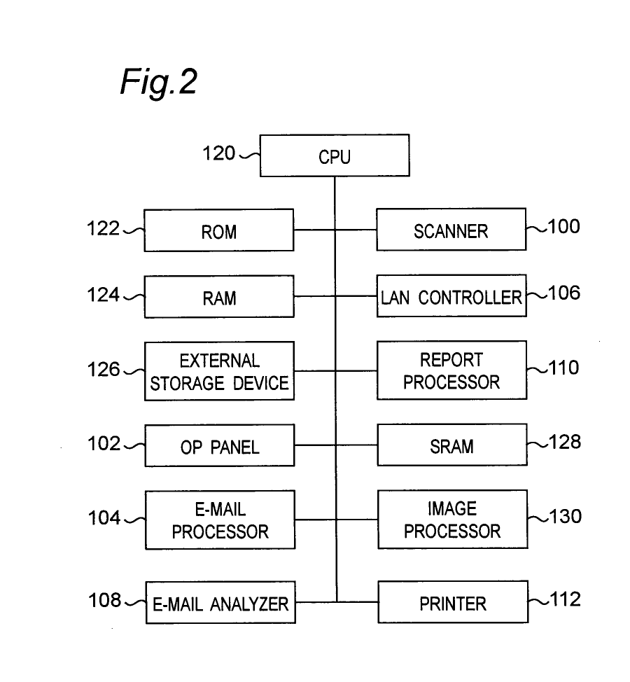

FIG. 2 shows a control system of the apparatus shown in FIG. 1. A central processing unit (hereinafter referred to as CPU) 120 is connected to a read only memory (ROM) 122 storing programs and the like, a random access memory (RAM) 124 used as a work area, an external storage device 126 such as a hard disk drive, a static random access memory (SRAM) 128 and an image processor 130. The CPU 120 is further connected to the scanner 100, the operational panel 102, the e-mail processor 104, the LAN controller 106, the e-mail analyzer 108, the report processor 110 and the printer 112. In the Internet facsimile function, image data obtained by the scanner 100 is processed by the image processor 130, and the processed image data to be transmitted are attached to an e-mail. A facsimile transmission data received from the external is processed by the image processor 130 and is printed by the printer 112. Further, data for transmission management report is stored in the SRAM 128. A transmission management report issued by the report processor 110 is printed by the printer 112. The e-mail processor 104 and the e-mail analyzer 108 are known software processings, and they are not explained here in detail. The report processor 110 performs a processing of a software program for creating a transmission management report, and the software program is explained later.

In a facsimile sending to an apparatus at a destination by the facsimile apparatus, it is requested to the apparatus to return confirmation of receipt. The request to return the result is an MDN request. Then, the destination apparatus sends confirmation of receipt (an MDN response). The facsimile apparatus issues a transmission management report according to the result of the confirmation of the receipt (the MDN response).

The transmission management report is issued at predetermined timings, for example, when a predetermined time such as 24 hours elapses, or when the number of facsimile transmissions reaches a predetermined number. In the transmission management report, result of each facsimile transmission is shown according to the MDN response for the MDN request or the result of confirmation of data receipt. In a facsimile apparatus according to the embodiment, an MDN response is waited for the predetermined time or wait time after a MDN request is sent. However, an output timing of the transmission management report may occur during the wait time. In the facsimile apparatus of this embodiment, the transmission management report includes data on transmission or transmissions on which the result of transmission is uncertain at the output timing of the report, that is, transmission or transmissions on which the confirmation of report is not received and on which the wait time has not elapsed at the output timing of the report. Thus, the transmission management report reflects a situation of the result of transmission on all the transmissions.

Table 1 shows an example of transmission management report. The items compiled in the transmission management report include mark, destination address (To), date and time of transmission, and result of transmission. In this embodiment, the above-mentioned predetermined number of transmissions to be listed in the transmission management report is thirteen. In the transmission management report shown in Table 1, the results of confirmation of transmissions (MDN responses) have already been received for nine among thirteen transmissions. That is, the result of transmission is stated only for the nine transmissions on which the MDN responses are received. A mark (*) is added for the remaining four transmissions, and it means that the MDN response has not yet been received and that the wait time has not yet elapsed when the report is issued. In other words, it means that the result of transmission is not certain for the four transmissions when the report is issued. Thus the situation on the result of all the transmissions can be displayed as a list.

TABLE 1
Transmission management report

| | | Date and time of | | Result of |
|---|---|---|---|---|
| Mark | To | Transmission | | transmission |
| | a@b | 2002.7.9. | 11:23 | delivered |
| | c@d | 2002.7.9. | 11:26 | undelivered |
| | e@f | 2002.7.9. | 11:30 | undelivered |
| | g@h | 2002.7.9. | 11:35 | undelivered |
| | i@j | 2002.7.9. | 11:42 | undelivered |
| | k@l | 2002.7.9. | 11:50 | undelivered |
| | m@n | 2002.7.9. | 12:31 | delivered |
| | o@p | 2002.7.9. | 12:37 | undelivered |
| | q@r | 2002.7.9. | 12:45 | undelivered |
| * | s@t | 2002.7.9. | 12:52 | |
| * | u@v | 2002.7.9. | 12:58 | |
| * | w@x | 2002.7.9. | 13:04 | |
| * | y@z | 2002.7.9. | 13:26 | |

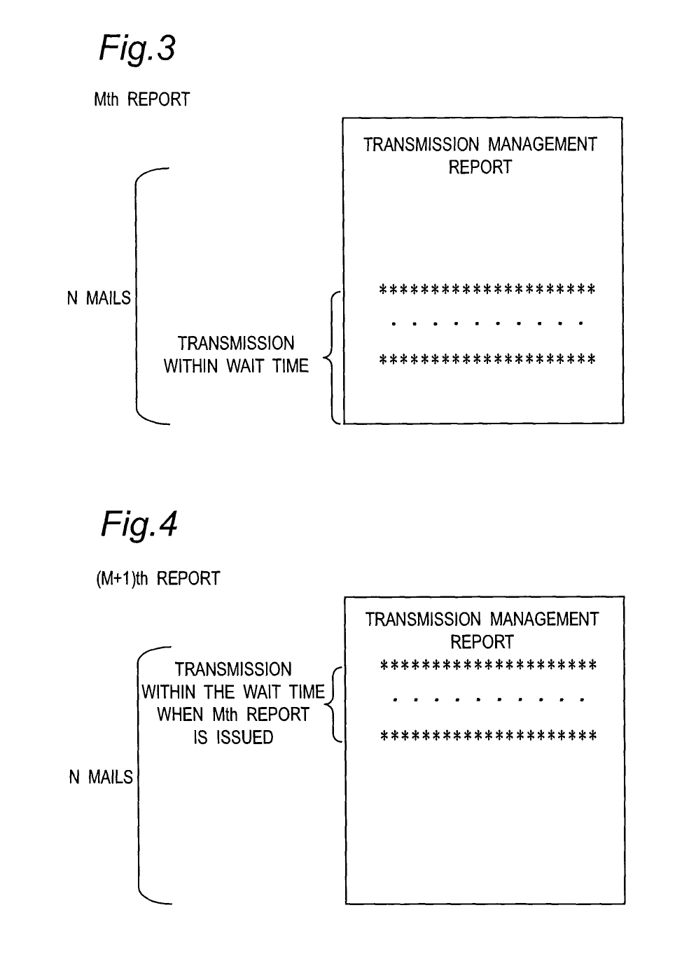

It is to be noted that the above-mentioned transmission or transmissions on which confirmation of receipt of transmission (MDN response) is not received and on which the wait time has not elapsed at the output timing of the report are also included in the next transmission management report. Therefore, a print area in a transmission management report has a structure as shown in FIGS. 3 and 4. A transmission management report shown in FIG. 3 includes the transmission or transmissions on which confirmation of receipt of transmission is uncertain, and the print area therefor is positioned at the last of the report. As shown in FIG. 4, the next transmission management report includes the transmission or transmissions on which the wait time had not elapsed at the output time of the previous transmission management report, and the print area therefor is positioned at the top of the report.

Previously, a transmission management report is issued when N mails (wherein N is a natural number) are sent. On the other hand, in the facsimile apparatus of this embodiment, a transmission management report is issued when transmissions of a number of {N—(the number of transmission or transmissions on which the wait time had not elapsed and confirmation of receipt (MDN response) had not been received when the last transmission management report was issued)} are sent. Further, the transmission or transmissions on which the wait time had not elapsed when the last transmission management report is issued are described in the next transmission management report. A situation of each of the above-mentioned transmission or transmissions that the MDN responses were received after the wait time elapsed or that the wait time has not elapsed is described in the transmission management report.

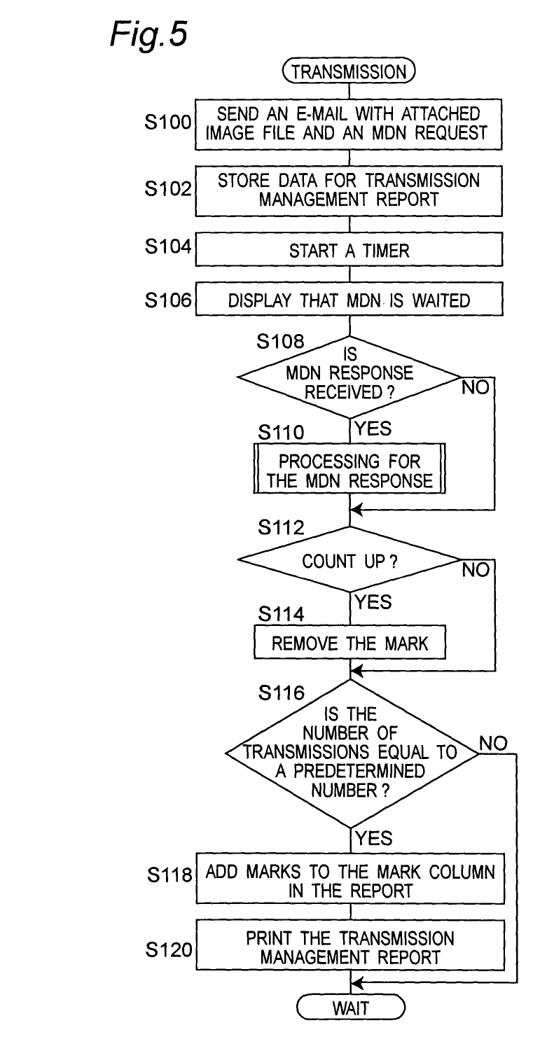

FIG. 5 is a flowchart for facsimile transmission (including issuance of transmission management report) according to a facsimile apparatus of this embodiment. It is executed by the CPU 120 according to the control program stored in the ROM 122 or in the external storage device 126. When facsimile transmission is instructed, an e-mail with attached image file (image data) and an MDN request are sent (S100). Then, data such as a destination of the e-mail and date and time of the transmission are stored, for example, in the external storage device 126 in order to be used for the transmission management report (S102).

Next, a timer is started (S104), and a message of “MDN response under waiting” is displayed in the operational panel 102 (S106).

Then, it is checked whether an MDN response for the transmission sent at step S100 is received or not (S108). If the MDN response is received (YES at S108), a processing therefor is performed (S110). If the MDN response is not received (NO at S108), the processing at step S110 is skipped.

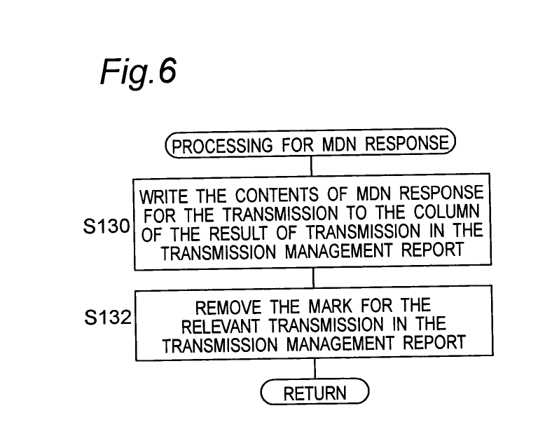

FIG. 6 shows a subroutine of the processing for MDN response performed at step S110. When the MDN response is received (S108 in FIG. 5), the contents of the MDN response (“delivered” or “undelivered”) is written for the transmission to the column of result of transmission in the transmission management report (S130). Further, if the mark had been added for the transmission at the column of mark in the transmission management report, the mark is removed (S132).

Returning to FIG. 5, it is checked whether the timer set at step S104 counts up to a predetermined number in correspondence to the predetermined time or not, or whether the predetermined time or wait time has elapsed or not (S112). When the wait time has elapsed (YES at S112), if the mark is added to the column of mark in the transmission management report, the mark is removed (S114). If the predetermined time has not elapsed (NO at S112), the processing at step S114 is skipped.

Next, it is checked whether the number of facsimile transmissions reaches to a predetermined number or not (S116). If the number of facsimile transmissions reaches to the predetermined number (YES at S116), marks are added to the mark column in the transmission management report for all the e-mails on which MDN responses have not yet been received and the wait time has not elapsed at this time (S118), and the transmission management report is printed (S120). Alternatively, data of the transmission management report is sent to a predetermined destination such as an administrator or a designated user, without printing the report. If the number of facsimile transmissions does not reach to the predetermined number (NO at S116), processings at steps S118 and S120 are skipped.

As explained above, because a transmission management report describes a transmission or transmissions on which the result of transmission is uncertain when the report is issued, a situation of all the transmissions can be displayed in a list. Therefore, the transmission management becomes easier.

The above-mentioned embodiment is explained with reference to an example of a multi-functional peripheral having the Internet facsimile function. However, the invention is not limited to such a multi-functional peripheral. For example, the invention can be applied to a dedicated facsimile apparatus having the Internet facsimile function. Further, the invention can be applied to any apparatus which can send and receive an e-mail with attached data, such as a mobile phone, a personal digital assistant or a personal computer.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A data transmission apparatus comprising:
a sender which sends an e-mail and a request of returning confirmation of receipt of the e-mail to a destination;
a receiver which receives the confirmation of receipt from the destination; and
a controller which issues a transmission management report at predetermined timings, describing result of transmission for a plurality of transmissions in the transmission management report, wherein said controller describes in the transmission management report a transmission or transmissions on which the result of transmission is uncertain when the transmission management report is issued.

2. The data transmission apparatus according to claim 1, wherein the transmission or transmissions on which the result of transmission is uncertain include a transmission or transmissions on which the confirmation of result of transmission had not been received and a predetermined wait time had not elapsed when the transmission management report is issued.

3. The data transmission apparatus according to claim 1, wherein said controller describes in the transmission management report that the result of transmission is uncertain for the transmission or transmissions on which the result of transmission is uncertain.

4. The data transmission apparatus according to claim 1, wherein said controller describes in the transmission management report the transmission or transmissions on which a last transmission management report stated that the result of transmission is uncertain.

5. The data transmission apparatus according to claim 4, wherein said controller describes in the transmission management report that the result of transmission is certain if the result of transmission becomes certain for the transmission or transmissions, on which a last transmission management report stated that the result of transmission is uncertain, when the transmission management report is issued.

6. The data transmission apparatus according to claim 1, wherein the request of returning confirmation of receipt is based on an MDN.

7. A computer-readable storage device storing a program comprising steps of:
sending an e-mail and a request of returning confirmation of receipt of the e-mail to a destination;
receiving the confirmation of receipt from the destination; and
issuing a transmission management report at predetermined timings, the transmission management report describing result of transmission for a plurality of transmissions in the transmission management report, the transmission management report further describing a transmission or transmissions on which the result of transmission is uncertain when the transmission management report is issued.

8. The computer-readable storage device according to claim 7, wherein the transmission or transmissions on which the result of transmission is uncertain include a transmission or transmissions on which the confirmation of receipt had not been received and a predetermined wait time had not elapsed when the transmission management report is issued.

9. The computer-readable storage device according to claim 7, wherein in said issuing step it is described in the transmission management report that the result of transmission is uncertain for the transmission or transmissions on which the result of transmission is uncertain.

10. The computer-readable storage device according to claim 7, wherein in said issuing step the transmission or transmissions on which a last transmission management report stated that the result of transmission is uncertain are described in the transmission management report.

11. The computer-readable storage device according to claim 10, wherein in said issuing step it is described in the transmission management report that the result of transmission is certain if the result of transmission becomes certain for the transmission or transmissions, on which a last transmission management report stated that the result of transmission is uncertain, when the transmission management report is issued.

12. The computer-readable storage device according to claim 7, wherein the request of returning confirmation is based on an MDN.
